(19) United States
(12) Patent Application Publication
(10) Pub. No.: US 2013/0268684 A1
(43) Pub. Date: Oct. 10, 2013

(54) DEVICE FOR MULTIPLE ETHERNET CONNECTION TO A COMPUTER UNIT AND COMPUTER UNIT ASSEMBLY AND EQUIPMENT LINKED TOGETHER

(71) Applicants: Jean-Marie Courteille, Paris (FR); Francois Guillot, Paris (FR)

(72) Inventors: Jean-Marie Courteille, Paris (FR); Francois Guillot, Paris (FR)

(21) Appl. No.: 13/992,974

(22) PCT Filed: Dec. 9, 2011
(86) PCT No.: PCT/EP11/72380

§ 371 Date: Jun. 10, 2013

(30) Foreign Application Priority Data
Dec. 17, 2010 (FR) 1060693

(51) Int. Cl. H04L 29/06

(52) U.S. Cl. CPC H04L 65/1013
USPC 709/227

(57) ABSTRACT

A device for making multiple connections to a computer unit, the device comprising at least one main connection provided with a connector for connection to the computer unit and connected via a switch module to a plurality of secondary connections, each provided with an external connector and together presenting an overall data rate equal to a maximum data rate of the main connection. An assembly comprising a computer unit and pieces of equipment connected thereto by a multiple connection device.

The present invention relates to a device for making multiple connections to a computer unit. The invention also provides an assembly comprising a computer unit and pieces of equipment.

It is known to connect a computer unit, such as a computer or a server, to pieces of equipment such as peripherals, computers, routers, or indeed other pieces of electronic network equipment.

For this purpose, the computer unit and the pieces of equipment are provided with network ports enabling data to be exchanged by establishing connections between them, e.g. connections of the Ethernet type.

In networks that are subjected to a severe security constraint, it is important for the ports of the computer unit to be mutually sealed off, i.e. it is important that no data can transit from one port to another unless the processor of the computer unit has commanded such a transit.

Under such conditions, the processor must also control bandwidth, latency, jitter, . . . in order to ensure that data is not rejected or lost in untimely manner, and also in order to prevent a connection becoming clogged.

For this purpose, the builders of central units make use of motherboards that present a plurality of ports under the control of the processor of the central unit.

Nevertheless, it often happens that the number of ports of commonly available central units is insufficient.

Central units exist that are fitted with a microcontroller having greater numbers of ports. Nevertheless, such microcontrollers are produced in small numbers, making them expensive and leading to them becoming obsolete relatively quickly. Knowledge of the internal operation of the microprocessor is also unknown to the purchasers of such microcontrollers.

Another solution, which is less expensive, is to connect the central unit to an Ethernet switch. Nevertheless, the ranges made available by switch manufacturers are renewed relatively quickly, thus making it impossible to guarantee continuity of supply of such switches. In addition, data is shared among the ports in a manner that is independent of the microprocessor of the central unit.

Yet another solution consists in the central unit being provided with additional Ethernet interfaces having Ethernet ports. This requires an internal bus infrastructure that is considerable. The parallel buses that are used for this purpose are replaced by buses of the PCIexpress type that present greater performance. Nevertheless, that protocol is complicated and requires the bus to be managed under software control. It is also difficult to guarantee transmission security.

An object of the invention is to provide means enabling the number of connections to a central unit to be increased while limiting the risk of a breach of transmission security.

For this purpose, the invention provides a device for making multiple connections to a computer unit, the device comprising at least one main connection provided with a connector for connection to the computer unit and connected via a switch module to a plurality of secondary connections, each provided with an external connector and together presenting an overall data rate at most substantially equal to a maximum data rate of the main connection.

Thus, the device presents a structure that is simple, enabling multiple connections to be made without changing a communications protocol. The secondary connections are not connected to one another, but only to the main connection via the switch module. The switch module is used on transmission only for routing the transmitted frames to the respective corresponding secondary connections, and on reception it serves only for transferring frames from the secondary connections to the main connection: the switch module does not enable the secondary connections to be interconnected directly. Finally, this simplicity enables the device to be connected to numerous types of computer unit, since the device can be managed without requiring major resources whether in terms of hardware or software. This type of architecture makes it possible to achieve relatively good deterministic control over bandwidth, latency, and jitter.

Preferably, each secondary connection includes a frame management module.

This provides better control over communications parameters including bandwidth, and it off-loads at least some of the frame management from the computer unit.

Advantageously, the management module presents at least one of the following characteristics:
the frame management module is arranged to order frames and, preferably, the ordering is of the first-in, first-out type; and
the frame management module is arranged to reject frames as a function of at least one predetermined criterion.

Preferably, the management module has a configuration input connected to the main connection, or alternatively, the frame management module has a configuration input connected via an additional connection to a connector for connection to the computer unit.

This enables the computer unit to control the frame management module directly, e.g. for the purpose of adapting management settings to varying constraints that apply to exchanging data between the computer unit and the pieces of equipment.

The invention also provides an assembly comprising a computer unit and pieces of equipment connected to the computer unit via a device comprising a main connection having a connector for connection to the computer unit and connected by a switch module to a plurality of secondary connections, each provided with a connector for connection to a respective piece of equipment, the computer unit and the pieces of equipment all being programmed to avoid transmitting frames over the secondary connections that are greater in size and number than predetermined thresholds so that the secondary connections convey an overall data rate that is at most substantially equal to a maximum data rate of the main connection.

There is thus no need to provide a physical limit on data rate over the secondary connections, with this limit being the result of programming the computer unit and programming the pieces of equipment so as to limit the size of frames transmitted over the secondary connections.

Other characteristics and advantages of the invention appear on reading the following description of particular, non-limiting embodiments of the invention.

Reference is made to the accompanying drawing, in which:

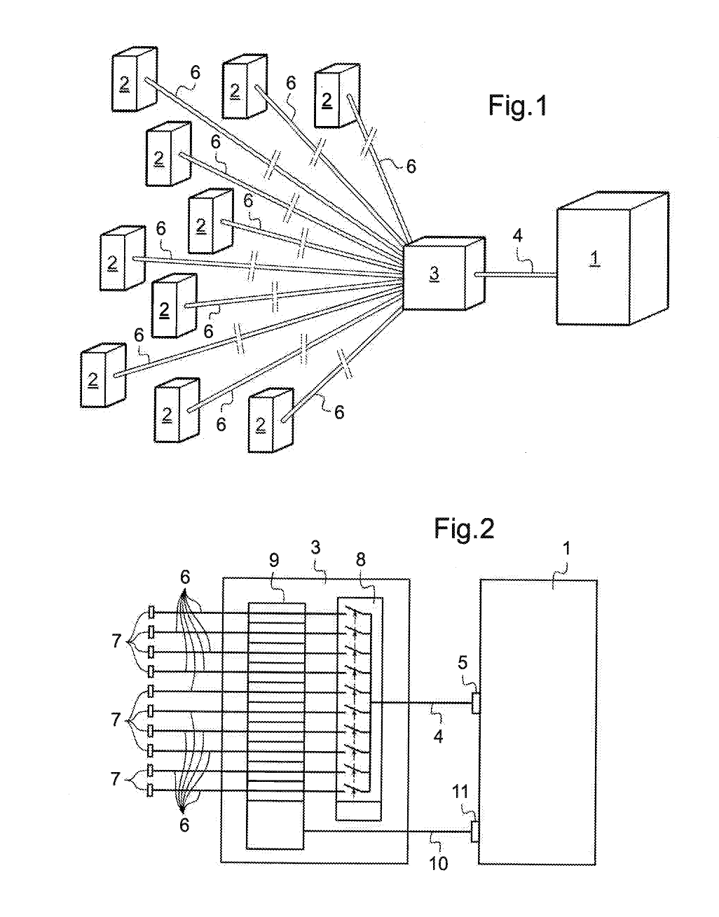

FIG. 1 is a diagrammatic view of an assembly of the invention comprising a computer unit and equipment; and

FIG. 2 is a diagrammatic view of a multiple connection device in accordance with the invention.

FIG. 1 shows an assembly comprising a computer unit 1, such as a computer or a server, connected to pieces of equipment 2, such as pieces of electromechanical, electromagnetic, or electronic equipment such as actuators, computer peripherals, or computers.

The pieces of equipment 2 are connected to the computer unit via a connection device 3 having a main connection 4 provided with a connector 5 for connecting to the computer unit 1 and secondary connections 6, each provided with a connector 7 for connecting to a respective one of the pieces of equipment 2. In this example, the connections 4 and 6 are of the Ethernet type, and the secondary connections 6 (ten secondary connections having unit data rates of 100 megabits per second (Mb/s)) present an overall data rate equal to a maximum data rate (1000 Mb/s) of the main connection 4. Naturally, the invention may be implemented using connections having data rates that are different from those mentioned above, and for example the data rates may be respectively 1000 Mb/s and 10,000 Mb/s.

The main connection 4 is connected to the secondary connection 6 by a switch module 8. The switch module 8 is arranged to connect each of the secondary connections 6 to the main connection 4. In the transmission direction from the main connection 4, the switch module 8 is arranged more particularly to route the transmitted frames to the secondary connections 6 as a function of at least one of the following parameters: a source physical address (or “media access control” (MAC) address); and/or a tag that are contained in the frames. For the physical address, the computer unit 1 has a plurality of physical addresses, each of which is used for exchanging data with a particular piece of equipment, and thus over a particular secondary connection 6. With tags, it is possible to avoid using a physical address by using a tag that is inserted in the frame by the transmitting computer application. The switch module 8 has a table associating various tags each with one of the secondary connections 6 in such a manner that the switch module 8 selects the secondary connection 6 over which the frame is to be transmitted as a function of said tag.

Each secondary connection 6 has a frame management module 9 associated with the switch module 8.

The frame management module 9 has a buffer memory and is arranged to order frames, in this example a device of the first-in, first-out type. Thus, the first frame to be stored in the buffer memory is the first frame to leave it, and so on.

The frame management module 9 is also arranged to reject frames as a function of at least one predetermined criterion. This criterion may be the result of a security requirement (a frame including data that it is forbidden to transmit or receive, e.g. because of a security criterion relating to the type of frame), or a service requirement (e.g. a frame that is too large in size).

In this example, the frame management module 9 has a configuration input connected by an additional connection 10 to a connector 11 for connection to the computer unit 1. The additional connection 10 is of the Ethernet type. The computer unit 1 can thus control the frame management module 9 directly, e.g. by updating or modifying the frame-rejection criterion or criteria.

In a preferred variant, the configuration input is connected directly via the main connection 4 to the connector 5. Under such circumstances, configuration frames include a marker (or tag) indicating that the data contained in the frame is not for transmission over the secondary connections 6, but is for configuring the management module 9.

It can be understood that the device of the invention makes it possible to connect at least one computer unit to a plurality of pieces of equipment while using Ethernet connections but without making use of an intermediate protocol between the main connection and the secondary connections and without any possibility of data transiting directly between the secondary connections.

In another embodiment, the invention provides a set comprising a computer unit and pieces of equipment connected to the computer unit by a multiple connection device.

As in the first embodiment, the device has a main connection provided with a connector for connecting to the computer unit and connected via a switch module to a plurality of secondary connections, each provided with a connector for connection to one of the pieces of equipment.

In this example, the secondary connections all have the same theoretical data rate as the main connection (there is no physical limit on the data rate over the secondary connections).

The computer unit and the pieces of equipment are all programmed to avoid transmitting frames over the secondary connections that are greater in size or in number than predetermined thresholds, such that the secondary connections deliver an overall data rate that is substantially equal to the maximum data rate of the main connection. How to determine these thresholds is itself known and serves to avoid the main connection becoming clogged (in the receive direction) and to avoid one or more of the secondary connections becoming clogged (in the transmit direction).

Naturally, the invention is not limited to the embodiments described but covers any variant coming within the ambit of the invention as defined by the claims.

In particular, the structure of the device may be different from that described. For example, the device may include a plurality of main connections, the switch module then sharing the frames between the secondary connections and the main connections. The overall data rate of the main connections is substantially equal to the maximum data rate of the main connection having the lowest data rate.

In the embodiments described, all of the secondary connections have the same real unit data rate, but that it not essential. Furthermore, the overall data rate of the secondary connections in the embodiments described is substantially equal to the maximum data rate of the main connections, thereby enabling best use to be made of the connections. In a variant, it is possible for the overall data rate of the secondary connections to be less than the maximum data rate of the main connection instead of being equal thereto.

1. A device for making multiple connections to a computer unit, the device comprising at least one main connection provided with a connector for connection to the computer unit and connected via a switch module to a plurality of secondary connections, each provided with an external connector and together presenting an overall data rate equal to a maximum data rate of the main connection.

2. The device according to claim 1, wherein the connections are of the Ethernet type.

3. The device according to claim 1, wherein each secondary connection includes a frame management module.

4. The device according to claim 3, wherein the frame management module is arranged to order frames.

5. The device according to claim 4, wherein the ordering is of the first-in, first-out type.

6. The device according to claim 4, wherein the frame management module is arranged to reject frames as a function of at least one predetermined criterion.

7. The device according to claim 3, wherein the frame management module has a configuration input connected via the main connection to the connector for connection to the computer unit.

8. The device according to claim 3, wherein the frame management module has a configuration input connected via an additional connection to a connector for connection to the computer unit.

9. The device according to claim 8, wherein the additional connection is of the Ethernet type.

10. The device according to claim 1, wherein the switch module is arranged to route transmitted frames to the secondary connections as a function of at least one of the following parameters:
a source physical address appearing in each frame; and
a tag contained in each frame.

11. An assembly comprising a computer unit and pieces of equipment connected to the computer unit via a device according to any preceding claim and comprising a main connection having a connector for connection to the computer unit and connected by a switch module to a plurality of secondary connections, each provided with a connector for connection to a respective piece of equipment, the computer unit and the pieces of equipment all being programmed to avoid transmitting frames over the secondary connections that are greater in size and number than predetermined thresholds so that the secondary connections convey an overall data rate that is substantially equal to a maximum data rate of the main connection.
